(19) United States
(12) Patent Application Publication
(10) Pub. No.: US 2025/0092213 A1
(43) Pub. Date: Mar. 20, 2025

(54) RESIN REGENERATION METHOD AND RESIN REGENERATION APPARATUS

(71) Applicant: HONDA MOTOR CO., LTD., Tokyo (JP)

(72) Inventors: Kohei SHIBATA, Saitama (JP); Yoshinobu HATANO, Saitama (JP)

(21) Appl. No.: 18/668,258

(22) Filed: May 20, 2024

(30) Foreign Application Priority Data
Sep. 14, 2023 (JP) 2023-149365

(51) Int. Cl. C08J 11/12; H05B 6/64

(52) U.S. Cl. CPC C08J 11/12; H05B 6/6491

(57) ABSTRACT

Provided is a resin regeneration method comprising: irradiating a composition containing a resin and a filler capable of absorbing microwaves with the microwaves in an inert gas atmosphere to thermally decompose the resin by magnetic field heating; and collecting decomposition gas generated by thermal decomposition of the resin.

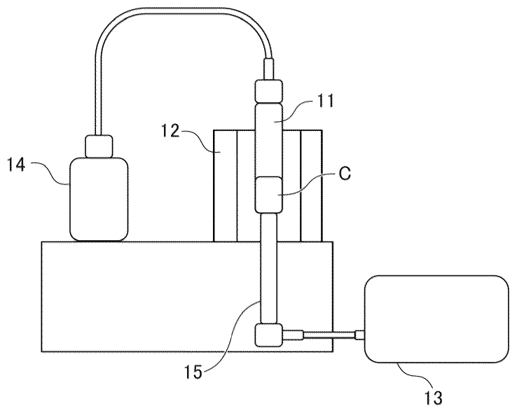

This application is based on and claims the benefit of priority from Japanese Patent Application No. 2023-149365, filed on 14 Sep. 2023, the content of which is incorporated herein by reference.

### BACKGROUND OF THE INVENTION

### Field of the Invention

The present invention relates to a resin regeneration method and a resin regeneration apparatus.

### Related Art

In recent years, efforts have been made to reduce the generation of waste through prevention, reduction, recycling, and reuse of waste. To achieve this, research and development have been conducted on a method for regenerating a resin.

Patent Document 1 describes a method for regenerating a plastic material. In this method, first, plastic granules having a desired particle size are formed by finely grinding a plastic material, and then the plastic granules are provided with a susceptor agent and a binder that impart specific dielectric properties to the plastic granules. The plastic granules provided with the susceptor agent and binder are then treated with microwave energy, and then a solid product is formed from the treated plastic granules.
Patent Document 1: Japanese Unexamined Patent Application (Translation of PCT application), Publication No. 2007-537894

### SUMMARY OF THE INVENTION

However, in the method described in Patent Document 1, recovery efficiency of a monomer cannot be improved because the plastic material is subjected to regeneration treatment without thermal decomposition.

An object of the present invention is to provide a resin regeneration method capable of improving the recovery efficiency of a monomer and a resin regeneration apparatus.

A first aspect of the present disclosure relates to a resin regeneration method including: irradiating a composition containing a resin and a filler capable of absorbing microwaves with the microwaves in an inert gas atmosphere to thermally decompose the resin by magnetic field heating; and collecting decomposition gas generated by the thermal decomposition of the resin.

A second aspect of the present disclosure relates to the resin regeneration method as described in the first aspect, in which the filler includes carbon, β-silicon carbide, or Mn—Zn-based soft ferrite.

A third aspect of the present disclosure relates to the resin regeneration method as described in the second aspect, in which the filler is a carbon fiber.

A fourth aspect of the present disclosure relates to the resin regeneration method as described in any one of the first to third aspects, in which the resin is polypropylene.

A fifth aspect of the present disclosure relates to the resin regeneration method as described in any one of the first to fourth aspects, in which a mass ratio of the filler with respect to the resin is 1.5 or more.

A sixth aspect of the present disclosure relates to a resin regeneration apparatus including: a reaction vessel housing a composition containing a resin and a filler capable of absorbing microwaves; a magnetic field heater that irradiates the composition housed in the reaction vessel with the microwaves to thermally decompose the resin by magnetic field heating; a decomposition gas collector that collects decomposition gas generated by the thermal decomposition of the resin; and an inert gas supplier that supplies an inert gas to the reaction vessel.

A seventh aspect of the present disclosure relates to the resin regeneration apparatus as described in the sixth aspect, in which the magnetic field heater includes: a microwave cavity resonator that houses the reaction vessel; and a frequency controller that controls a frequency of the microwave so that an intensity of a magnetic field at a center of the microwave cavity resonator becomes a local maximum.

According to the present invention, it is possible to provide a resin regeneration method and a resin regeneration apparatus capable of improving recovery efficiency of a monomer.

### BRIEF DESCRIPTION OF THE DRAWINGS

FIG. is a schematic view showing a resin regeneration apparatus according to one embodiment of the present disclosure.

### DETAILED DESCRIPTION OF THE INVENTION

Hereinafter, embodiments of the present disclosure will be described with reference to the drawing.

FIG. shows a resin regeneration apparatus according to an embodiment of the present invention.

A resin regeneration apparatus 10 includes: a tubular reaction vessel 11 housing a composition C containing a resin and a filler capable of absorbing microwaves; a magnetic field heater 12 that irradiates the composition housed in the reaction vessel 11 with microwaves to thermally decompose the resin by magnetic field heating, a decomposition gas collector 13 that collects decomposition gas generated by the thermal decomposition of the resin, and an inert gas supplier 14 that supplies an inert gas to the reaction vessel 11. Here, the reaction vessel 11 and the decomposition gas collector 13 are connected to each other via a pipe 15. In addition, a member (glass wool or the like) through which the decomposition gas and the inert gas are allowed to pass and the composition is not allowed to pass is disposed at an end portion of the reaction vessel 11 on a pipe 15 side.

In the resin regeneration apparatus 10, since the filler absorbs the microwaves irradiated to the composition and generates heat, the resin is thermally decomposed and decomposition gas containing a monomer is generated. At this time, since a large number of hot spots are generated by magnetic field heating, the resin is easily thermally decomposed, and the monomer recovery efficiency is improved.

On the other hand, when the composition contained in the reaction vessel 11 is irradiated with microwaves and the resin is thermally decomposed by electric field heating, the number of hot spots generated decreases, so that the resin is less likely to be thermally decomposed and the monomer recovery efficiency decreases.

The resin is not particularly limited as long as it generates decomposition gas containing a monomer by thermal decomposition, and examples thereof include a polyolefin (polypropylene or the like), a polyester (polyethylene terephthalate or the like), and a polyamide (nylon or the like).

A material constituting the filler is not particularly limited as long as it can absorb microwaves, and examples thereof include carbon, silicon carbide (such as a silicon carbide and β silicon carbide), ferrite (such as Mn—Zn-based soft ferrite), and barium titanate. Among these, carbon, β-silicon carbide, and Mn—Zn soft ferrite are preferable from the viewpoint of monomer recovery efficiency. Examples of the filler composed of carbon include a carbon fiber (such as a PAN-based carbon fiber and a pitch-based carbon fiber) and a carbon nanotube, and a carbon fiber is preferable.

An average fiber length of carbon fibers is preferably 100 μm or less and more preferably 50 μm or less. When the average fiber length of carbon fibers is 100 μm or less, the monomer recovery efficiency is improved. Note that the average fiber length of carbon fibers is, for example, 5 μm or more.

A mass ratio of the filler with respect to the resin is preferably 1.5 or more and more preferably 3 or more. When the mass ratio of the filler with respect to the resin is 1.5 or more, the recovery efficiency of the monomer is improved. The mass ratio of the filler with respect to the resin is, for example, 10 or less.

A material constituting the reaction vessel 11 is not particularly limited as long as it is capable of transmitting microwaves, and examples thereof include quartz.

The magnetic field heater 12 is not particularly limited as long as it can irradiate the composition housed in the reaction vessel 11 with microwaves and magnetic field heating can decompose the resin. Here, the magnetic field heater 12 includes a microwave cavity resonator that houses the reaction vessel 11 and a frequency controller that controls the frequency of the microwave so that the intensity of the magnetic field at the center of the microwave cavity resonator becomes a local maximum.

As a commercially available product of the magnetic field heater 12, for example, a microwave reactor MR-2G-100 (manufactured by Ryowa Electronics Co., Ltd.) can be exemplified. The microwave reactor MR-2G-100 includes a cylindrical microwave cavity resonator in which a standing wave of TM010 mode is formed, and a frequency controller that controls the frequency of the microwave so that the intensity of the magnetic field at the central axis of the microwave cavity resonator becomes a local maximum.

The decomposition gas collector 13 is not particularly limited as long as it can collect decomposition gas.

The inert gas supplier 14 is not particularly limited as long as it can supply inert gas to the reaction vessel 11, and examples thereof include a cylinder filled with inert gas. Examples of the inert gas include nitrogen gas.

A resin regeneration method according to one embodiment of the present disclosure includes irradiating a composition containing a resin and a filler capable of absorbing microwaves with microwaves in an inert gas atmosphere to thermally decompose the resin by magnetic field heating, and collecting decomposition gas generated by the thermal decomposition of the resin. The resin regeneration method according to one embodiment of the present invention can be carried out using, for example, the resin regeneration apparatus 10.

Although the embodiments of the present invention have been described above, the present invention is not limited to the above-described embodiments, and the above-described embodiments may be appropriately modified within the scope of the gist of the present invention.

### EXAMPLES

Hereinafter, Examples of the present invention will be described, but the present invention is not limited to the Examples.

### Example 1

A regeneration sample was obtained by mixing 0.01 g of polypropylene pellets and 0.19 g of PAN-based carbon fiber CFMP-30X (manufactured by Nippon Polymer Sangyo Co., Ltd.) having an average fiber length of 40 μm. Next, the regeneration sample was placed in a reaction vessel by using the resin regeneration apparatus (see FIG.) and propylene gas was collected. At this time, a microwave reactor MR-2G-100 (manufactured by Ryowa Electronics Co., Ltd.) was used as the magnetic field heater, the frequency of the microwave was set to 2.45 GHz and the output of the microwave was set to 70 W. As the reaction vessel, an accompanying reaction tube made of quartz glass was used. Nitrogen gas was supplied to the reaction vessel at 0.5 L/min using a nitrogen cylinder as the inert gas supplier. A gas bag was used as the decomposition gas collector, and the decomposition gas was collected together with the nitrogen gas supplied from the nitrogen cylinder. The collected decomposition gas was analyzed using Agilent 6890N gas chromatograph and a PoraBOND Q column (manufactured by Agilent Technologies), resulting in a monomer recovery efficiency (ratio of collected amount of propylene gas with respect to a total amount of nitrogen gas and decomposition gas) of 680 μL/L.

### Example 2

The decomposition gas was collected in the same manner as in Example 1 except that PAN-based carbon fiber CFMP-150X (manufactured by Nippon Polymer Sangyo Co., Ltd.) having an average fiber length of 100 μm was used instead of PAN-based carbon fiber CFMP-30X (manufactured by Nippon Polymer Sangyo Co., Ltd.) having an average fiber length of 40 μm, resulting in a monomer recovery efficiency of 6.9 μL/L.

### Example 3

The decomposition gas was collected in the same manner as in Example 1 except that carbon nanotube TC-2000 (manufactured by Toda Kogyo) having an average tube diameter of 16 nm and a length of 1 to 5 μm was used instead of the carbon fiber, resulting in a monomer recovery efficiency of 380 μL/L.

### Example 4

The decomposition gas was collected in the same manner as in Example 1 except that Mn—Zn-based soft ferrite BSF-547 (manufactured by Toda Kogyo Corp.) having an average particle diameter of 3.20 μm was used instead of the carbon fiber, resulting in a monomer recovery efficiency of 580 μL/L.

### Example 5

The decomposition gas was collected in the same manner as in Example 1 except that α-silicon carbide (α-SiC) 2500N (manufactured by Superior Graphite) having an average particle diameter of 0.5 μm was used instead of the carbon fiber, resulting in a monomer recovery efficiency of 80 μL/L.

### Example 6

The decomposition gas was collected in the same manner as in Example 1 except that β-silicon carbide (β-SiC) 220 (manufactured by Superior Graphite) having an average particle diameter of 300 μm was used instead of the carbon fiber, resulting in a monomer recovery efficiency of 760 μL/L.

### EXPLANATION OF REFERENCE NUMERALS

10 Resin regeneration apparatus
11 Reaction vessel
12 Magnetic field heater
13 Decomposition gas collector
14 Inert gas supplier
15 Tube
C Composition

What is claimed is:

1. A resin regeneration method comprising: irradiating a composition containing a resin and a filler capable of absorbing microwaves with the microwaves in an inert gas atmosphere to thermally decompose the resin by magnetic field heating; and
collecting decomposition gas generated by thermal decomposition of the resin.

2. The resin regeneration method according to claim 1, wherein the filler comprises carbon, β-silicon carbide, or Mn—Zn-based soft ferrite.

3. The resin regeneration method according to claim 2, wherein the filler is a carbon fiber.

4. The resin regeneration method according to claim 1, wherein the resin is polypropylene.

5. The resin regeneration method according to claim 1, wherein a mass ratio of the filler with respect to the resin is 1.5 or more.

6. A resin regeneration apparatus comprising:
a reaction vessel that houses a composition containing a resin and a filler capable of absorbing microwaves;
a magnetic field heater that irradiates the composition housed in the reaction vessel with the microwaves to thermally decompose the resin by magnetic field heating;
a decomposition gas collector that collects decomposition gas generated by thermal decomposition of the resin; and
an inert gas supplier that supplies an inert gas to the reaction vessel.

7. The resin regeneration apparatus according to claim 6, wherein the magnetic field heater comprises: a microwave cavity resonator that houses the reaction vessel; and a frequency controller that controls a frequency of the microwave so that intensity of a magnetic field at a center of the microwave cavity resonator becomes a local maximum.
